(19) United States
(12) Patent Application Publication
(10) Pub. No.: US 2015/0368457 A1
(43) Pub. Date: Dec. 24, 2015

(54) TOUGHENED EPOXY THERMOSETS CONTAINING CORE SHELL RUBBERS AND POLYOLS

(71) Applicant: BLUE CUBE LLC, Midland, MI (US)

(72) Inventors: Sara B. KLAMO, Houston, TX (US); Rui XIE, Pearland, TX (US); Gyongyi GULYAS, Lake Jackson, TX (US); Maurice J. MARKS, Lake Jackson, TX (US)

(21) Appl. No.: 14/766,204

(22) PCT Filed: Oct. 13, 2013
(86) PCT No.: PCT/US2013/064743

§ 371 Date: Aug. 6, 2015

Related U.S. Application Data
(60) Provisional application No. 61/791,683, filed on Mar. 15, 2013.

(51) Int. Cl. C08L 63/00; C09J 163/00; C09D 121/00; C09J 121/00; C08L 21/00; C09D 163/00

(52) U.S. Cl. CPC C08L 63/00; C08L 21/00; C09D 163/00; C09D 121/00; C09J 121/00; C09J 163/00

(57) ABSTRACT

A curable resin composition comprising: a) an epoxy resin; b) an anhydride hardener; c) a polyol; d) a core shell rubber, and (e) a catalyst, is disclosed. When cured, the resin composition can be used to formulate composites, coatings, laminates, and adhesives.

### BACKGROUND OF THE INVENTION

1. Field of the Invention

The present invention is related to toughening epoxy resin compositions; and more specifically, the present invention is related to the use of a polyol and core shell rubber (CSR) toughening agents in epoxy resin compositions.

2. Background

There are various known methods for toughening epoxy-anhydride thermosets using a number of available known toughening agents such as CSRs or polyols. A major disadvantage in the use of CSRs as toughening agents in epoxy formulations is the significant increase in formulation viscosity. Compared to CSRs, polyols provide a lesser increase of the formulation viscosity, but they do not provide the same degree of increase in fracture toughness while also having a limited detrimental effect, if any, on the glass transition temperature (T_{g}).

It is therefore desired to provide a curable epoxy formulation with a toughening agent that will improve the flexibility, elongation, and toughness of the formulation with a minimal increase in formulation viscosity and with no decrease or detrimental affect on the T_{g} of the final thermoset made from the epoxy formulation.

### SUMMARY OF THE INVENTION

The present invention is directed to the use of polyol and core shell rubber (CSR) toughening agents in certain total amounts and ratios for toughening an epoxy-anhydride formulation without compromising some of the mechanical and thermal properties of the thermoset and providing good processability.

Advantageously, the use of polyol and core shell rubber (CSR) toughening agents in a curable epoxy formulation provide a low viscosity for improved processing and a thermoset product with an improved flexibility and elongation without sacrificing final T_{g} of the resulting thermoset.

One embodiment of the present invention is directed to a curable resin composition or system (or formulation) comprising, consisting of, or consisting essentially of (a) at least one epoxy resin; (b) at least one anhydride curing agent; (c) at least one polyol (d) at least one core shell rubber (CSR); and (e) at least one curing catalyst.

### DETAILED DESCRIPTION OF THE INVENTION

### Epoxy Resin

The present invention curable composition includes at least one epoxy resin, component (a). The epoxy resin may be saturated or unsaturated, aliphatic, cycloaliphatic, aromatic or heterocyclic and may be substituted. The epoxy resin may also be monomeric or polymeric. An extensive enumeration of epoxy resins useful in the present invention is found in Lee, H. and Neville, K., “Handbook of Epoxy Resins,” McGraw-Hill Book Company, New York, 1967, Chapter 2, pages 257-307; incorporated herein by reference.

The epoxy resin, used in embodiments disclosed herein for component (a) of the present invention, may vary and include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. Further epoxy resins include epoxides of divinylbenzene or divinylnaphthalene. It is also possible to use a mixture of two or more epoxy resins. The epoxy resins, component (a), useful in the present invention for the preparation of the curable compositions, may be selected from commercially available products; for example, D.E.R®. 331, D.E.R. 332, D.E.R. 383, D.E.R. 334, D.E.R. 580, D.E.N. 431, D.E.N. 438, D.E.R. 736, or D.E.R. 732 epoxy resins available from The Dow Chemical Company or Syna 21 cycloaliphatic epoxy resin from Synasia. As an illustration of the present invention, the epoxy resin component (a) may be a mixture of a liquid epoxy resin, such as D.E.R. 383, an epoxy novolac DEN 438, a cycloaliphatic epoxide Syna 21, and a divinylarene dioxide, divinylbenzene dioxide (DVBDO) and mixtures thereof.

In some embodiments, the epoxy resin mixture may be present in the curable composition in an amount ranging from about 10 weight percent (wt. %) to about 90 wt. % of the curable composition, based on the total weight of the curable composition, including the epoxy resin, the anhydride curing agent, the polyol, CSR and the catalyst. In other embodiments, the epoxy composition may range from about 20 wt. % to about 80 wt. % of the curable composition; in other embodiments; from about 30 wt. % to about 70 wt. %.

### Anhydride Curing Agent

The curing agent (also referred to as a hardener or cross-linking agent), component (b), useful for the curable epoxy resin composition of the present invention, may comprise cycloaliphatic and/or aromatic anhydrides; and mixtures thereof.

Cycloaliphatic anhydride hardeners may include, for example, nadic methyl anhydride, hexahydrophthalic anhydride, tetrahydrophthalic anhydride, methyl tetrahydrophthalic anhydride, methyl hexahydrophthalic anhydride and their derivatives among others; and mixtures thereof. Aromatic anhydrides may include, for example, phthalic anhydride, trimellitic anhydride and mixtures thereof. Anhydride curing agent may also include copolymers of styrene and maleic anhydride and other anhydrides described, for example, in U.S. Pat. No. 6,613,839 and Epoxy Resins Chemistry and Technology, ed. C. A. May, Y. Tanaka, Marcel Dekker Inc. 1973 New York, p 273-280, incorporated herein by reference.

In some embodiments, the anhydride hardener or a mixture of anhydride hardeners may be present in the curable composition in an amount ranging from about 10 wt. % to about 90 wt. % of the curable composition, based on the total weight of the epoxy resin mixture, the anhydride hardener, the polyol, CSR and the catalyst. In other embodiments, the anhydride hardener may generally range from about 20 wt. % to about 80 wt. % of the curable composition; from about 30 wt. % to about 70 wt. %; from about 30 wt. % to about 50 wt. %.

### Polyol

Generally, the polyol component, component (c), comprises a polyol or a mixture of polyols with a number average molecular weight of greater than about 2,000 to about 20,000, from about 3,000 to about 15,000 in another embodiment, and from about 4,000 to about 10,000 in yet another embodiment.

The average functionality of the polyol component is in the range of from 1.5 to 6.0. The average functionality of the polyol component is in the range of 2 to 4 in another embodiment.

Examples of the polyol component include, but are not limited to polyether polyols, such as polypropylene oxide, polybutylene oxide, polyethylene oxide, and polytetramethylene ether glycol commercially available from the Dow Chemical Company as VORANOL® polyols, from the Arch Chemical Company as Poly G® glycol, from Invista as TERATHANE®, and from the Bayer Corporation ACCLAIM® polyol, polyester polyols, such as polyethylene adipate, polybutylene adipate, polypropylene adipate, polyethylene propylene adipate, polyethylene butylene adipate, and the like, mixtures and copolymers thereof commercially available from Chemtura as FOMREZ® polyester polyols, and from The Dow Chemical Company as DIOREZ® polyester polyols, a polycaprolactone polyol, such as CAPA® caprolactone polyols from Perstorp and PLACCEL® caprolactone polyols from Daicel, polycarbonate polyols, such as Oxymer M112 from Perstorp, hydroxyl-terminated polybutadienes, such as KRASOL® from SARTOMER, and mixtures and copolymers of the above.

In some embodiments, the polyol may be present in the curable composition in an amount ranging from about 1 wt. % to about 30 wt. %. In other embodiments, the polyol may be present in an amount ranging from about 1 wt. % to about 20 wt. %; from about 5 wt. % to about 25 wt. %; from about 2 wt. % to about 15 wt. % in other embodiments; and from about 3 wt. % to about 10 wt. % in yet other embodiments, wherein the above ranges are based on the total weight of the epoxy resin mixture, the anhydride hardener, the polyol, CSR and the catalyst.

### CSR

The core shell rubber, component (d) used in the present invention comprises a rubber particle core and a shell layer. The core shell rubber generally has a particle size in the range of from 0.01 μm to 0.8 μm. The core shell rubber has a particle size in the range of from 0.05 μm to 0.5 μm, in another embodiment, and in the range of from 0.08 μm to 0.30 μm in yet another embodiment.

The core shell rubber is a polymer comprising a rubber particle core formed by a polymer comprising an elastomeric or rubbery polymer as a main ingredient, optionally having an intermediate layer formed with a monomer having two or more double bonds and coated on the core layer, and a shell layer formed by a polymer graft polymerized on the core. The shell layer partially or entirely covers the surface of the rubber particle core by graft polymerizing a monomer to the core.

Generally the rubber particle core is constituted from acrylic or methacrylic acid ester monomers or diene (conjugated diene) monomers or vinyl monomers or siloxane type monomers and combinations thereof.

The shell layer provides compatibility to the formulation and has limited swellability to facilitate mixing and dispersion of the CSR particles in the resin or hardener of the current invention. In one embodiment the shell does not have reactive groups towards the epoxy resin or the hardener of the present invention. Yet in another embodiment the shell might have reactive groups towards the epoxy resin or the hardener, for example epoxide or carboxylic acid groups.

CSR, component (d), useful in the present invention for the preparation of the curable compositions, may be selected from commercially available products; for example, Paraloid EXL 2650A, EXL 2655, EXL2691 A, each available from The Dow Chemical Company, or Kane Ace® MX series from Kaneka Corporation, such as MX 120, MX 125, MX 130, MX 136, MX 551, or METABLEN SX-006 available from Mitsubishi Rayon.

Generally, the CSR component, component (d), may be present in the curable composition in an amount ranging from about 1 wt. % to about 25 wt. %. In other embodiments, the CSR may be present in an amount ranging from about 2 wt. % to about 20 wt. %; from about 3 wt. % to about 15 wt. % in other embodiments; wherein the above ranges are based on the total weight of the epoxy resin mixture, the anhydride hardener, the polyol, CSR and the catalyst.

The present invention uses two different toughening agents, a polyol and a CSR. The relative and total amounts of the toughening agents is also important regarding obtaining minimum viscosity of the combination of anhydride, CSR, and polyol, and reaching maximum flexibility and elongation without having a detrimental effect on T_{g} of the cured epoxy thermoset prepared using the present invention. Generally, the minimum of the weight ratio of CSR to polyol in the curable composition may range from about 0.1 to about 2, such as, for example, from about 0.5 to about 2. The maximum of the weight ratio of CSR to polyol in the curable composition may range from about 2 to about 15, such as, for example, from about 2 to about 7. Generally, the combined minimum amount of the polyol and CSR in the curable composition may range from 2 wt. % to about 10 wt. %, such as, for example, 3 wt. % to about 5 wt. %. The combined maximum amount of the polyol and CSR in the curable composition may range from 8 wt. % to about 30 wt. %, such as, for example, 10 wt. % to about 20 wt. %. In some embodiments, the minimum percentage increase in viscosity of the combined anhydride, CSR, and polyol compared to the anhydride alone may range from about 50 to about 500, such as, for example, from about 100 to about 500.

### Catalyst

The catalyst component (e) of the epoxy resin composition of the present invention is a compound used to facilitate the curing of the formulation, and may include for example, at least one tertiary amine, including phenolic substituted ones; at least one boric acid-amine complex; at least one boron trifluoride-amine complex; at least one imidazole or substituted imidazole; at least one metal acetylacetonate (as described for example in Z. Zhang, C. P. Wong, Study on the Catalytic Behavior of Metal Acetylacetonates for Epoxy Curing Reactions, Journal of Applied Polymer Science, Vol. 86, 1572-1579 (2002)); at least one transition metal (for example cobalt, nickel, zinc, chromium, iron, copper) salt; at least one quaternary ammonium or phosphonium salts; at least one phosphine or substituted phosphine compound; or a combination thereof. Numerous catalyst or accelerators are described, for example, in Epoxy Resins Chemistry and Technology, ed. C. A. May, Y. Tanaka, Marcel Dekker Inc. 1973 New York, p 273-280, incorporated herein by reference.

In some embodiments, a catalyst may be present in the curable composition in an amount ranging from 0 wt. % to about 10 wt. % or from about 0.01 wt. % to about 7 wt. %. In other embodiments, the catalyst may be present in an amount ranging from about 0.1 wt. % to about 6 wt. %; from about 0.5 wt. % to about 5 wt. % in other embodiments; wherein the above ranges are based on the total weight of the epoxy resin mixture, the anhydride hardener, the polyol, the CSR and the catalyst. The reaction of epoxy and anhydride curing agent may be slow or may not occur outside the above concentration ranges of the catalyst.

### Optional Components

The curable or thermosettable composition of the present invention may optionally contain one or more other additives which are useful for their intended uses. For example, the optional additives useful in the present invention composition may include, but not limited to, non-reactive diluents, stabilizers, surfactants, flow modifiers, pigments or dyes, matting agents, degassing agents, flame retardants (e.g., inorganic flame retardants, halogenated flame retardants, and non-halogenated flame retardants such as phosphorus-containing materials), curing initiators, curing inhibitors, wetting agents, colorants or pigments, thermoplastics, processing aids, UV blocking compounds, fluorescent compounds, UV stabilizers, inert fillers, fibrous reinforcements, antioxidants, impact modifiers including thermoplastic particles, and mixtures thereof. The above list is intended to be exemplary and not limiting. The preferred additives for the, formulation of the present invention may be optimized by the skilled artisan.

Curable compositions may also include from 0 wt. % to about 70 wt. % optional additives in some embodiments; and from about 0.1 wt. % to about 50 wt. % optional additives in other embodiments based on the total weight of the curable composition. In other embodiments, curable compositions may include from about 0.1 wt. % to about 10 wt. % optional additives; and from about 0.5 wt. % to about 5 wt. % optional additives in yet other embodiments.

### Process for Producing the Composition

In an embodiment of the invention, there is disclosed a process for preparing the above-mentioned composition comprising, consisting of, or consisting essentially of two steps. The first step is dispersing the core shell rubber into an epoxy component, or a hardener component, or a polyol component. The second step is admixing the CSR dispersion with the appropriate amounts of the epoxy resin, the anhydride hardener, the polyol and the catalyst.

In an embodiment, the first step, CSR dispersion is prepared with a high shear mixer in a dispersion zone under dispersion conditions wherein said dispersion zone does not contain a solvent and wherein said dispersion conditions comprise a dispersion temperature of 40° C. to 100° C., a Reynolds Number greater than 10, and a dispersion time of from 30 minutes to 300 minutes.

In an embodiment, the high speed mixer is equipped with a variable speed control, a temperature probe and a cowles mixing blade or variations of a cowles. To achieve the best mixing results, the diameter of the cowles mixing blade (D) is generally between 0.2 to 0.7 of the diameter of the vessel (T) (D/T=0.2˜0.7), between 0.25 to 0.50 in another embodiment, and between 0.3 to 0.4 in yet another embodiment. The blade clearance from the bottom of the vessel is generally 0.2 D to 2.0 D, 0.4 D to 1.5 D in another embodiment, and 0.5 D to 1.0 D in yet another embodiment. The height of the mixture (H) is generally between 1.0 D to 2.5 D, between 1.25 D to 2.0 D in another embodiment, and between 1.5 D to 1.8 D in yet another embodiment. The dispersion zone generally has a dispersion temperature in the range of from 0° C. to 100° C. The dispersion zone has a dispersion temperature in the range of from 25° C. to 90° C. in another embodiment, and a dispersion temperature in the range of from 60° C. to 80° C. in yet another embodiment.

The Reynolds number is a measure of the ratio of inertial forces to viscous forces. Generally, the dispersion zone is maintained at a Reynolds number of greater than 10. The dispersion zone is maintained at a Reynolds number of greater than 100 in another embodiment and is maintained at a Reynolds number of greater than 300 in yet another embodiment.

The dispersion zone is maintained at the dispersion conditions for as long as necessary to achieve a uniform, single/discrete particle dispersion. In an embodiment, the dispersion zone is maintained at the dispersion conditions for a time in the range of 30 minutes to 300 minutes. In an embodiment, a vacuum can be applied to remove any entrapped air.

In an embodiment, the dispersion formed by this process contain 5 wt. % to 45 wt. % of polymer particles. The dispersion formed contains 10 wt. % to 40 wt. % of polymer particles in another embodiment, and contain 25 wt. % to 30 wt. % of polymer particles in yet another embodiment.

The second step of the preparation of the curable epoxy resin composition of the present invention is achieved by admixing the reaction components above. For example, the epoxy resin, the curing agent, the polyol, the CSR dispersion, and the catalyst, may be added to a mixing vessel; and the components are then formulated into an epoxy resin composition by mixing. There is no criticality to the order of mixture, i.e., the components of the formulation or composition of the present invention may be admixed in any order to provide the curable composition of the present invention.

Any of the above-mentioned optional assorted formulation additives, for example fillers, may also be added to the composition during the mixing or prior to the mixing to form the curable composition.

All the components of the epoxy resin composition are typically mixed and dispersed at a temperature enabling the preparation of an effective epoxy resin composition having a low viscosity for the desired application. The temperature during the mixing of all components may be generally from about 0° C. to about 100° C. and from about 20° C. to about 50° C. in other embodiments.

### Curable Composition

Curable compositions may be formed, as described above, by combining (1) an aromatic epoxy resin or a cycloaliphatic epoxy resin or a mixture of a cycloaliphatic epoxy resin, an aromatic epoxy resin cycloaliphatic resin, an epoxy phenolic novolac resin, an epoxy bisphenol A novolac resin, a multifunctional epoxy resin, a bisphenol-A or bisphenol F based epoxy resin, with (2) an anhydride hardener, (3) polyol, (4) CSR and (5) a catalyst. Additionally other additives may also be added, as described above. The relative proportions of the epoxy resin mixtures and the anhydride hardener may depend, in part, upon the properties desired in the curable composition or thermoset compositions to be produced, the desired cure response of the composition, and the desired pot life of the composition. “Potlife” herein means the time it takes to increase the viscosity to double or triple the initial viscosity of the formulation at application temperature.

The viscosity of the epoxy resin composition prepared by the process of the present invention ranges generally from about 0.1 Pa-s to about 500 Pa-s at 25° C.

### Process for Curing the Composition

The curable epoxy resin formulation or composition of the present invention can be cured under conventional processing conditions to form a thermoset. The process to produce the thermoset products of the present invention may be performed by gravity casting, vacuum casting, automatic pressure gelation (APG), vacuum pressure gelation (VPG), infusion, filament winding, lay up injection, resin transfer molding, prepreging, dipping, coating, spraying, brushing, and the like.

The curing reaction conditions include, for example, carrying out the reaction under a temperature, generally in the range of from about 0° C. to about 300° C.; from about 20° C. to about 250° C. in other embodiments; and from about 50° C. to about 200° C. in yet other embodiments.

The pressure of the curing reaction may be carried out, for example, at a pressure of from about 0.01 bar to about 1000 bar; from about 0.1 bar to about bar 100 in other embodiments; and from about 0.5 bar to about 10 bar in yet other embodiments.

The curing of the curable or thermosettable composition may be carried out, for example, for a predetermined period of time sufficient to cure the composition. For example, the curing time may be chosen between about 1 minute to about 10 hours, between about 2 minutes to about 5 hours in other embodiments, and between about 2.5 minutes to about 1 hour in yet other embodiments.

The curing process of the present invention may be a batch or a continuous process. The reactor used in the process may be any reactor and ancillary equipment well known to those skilled in the art.

### Substrates

In one embodiment, the curable compositions described above may be dispensed on a substrate and cured. The substrate is not subject to particular limitation. As such, substrates may include metals, such as stainless steel, iron, steel, copper, zinc, tin, aluminum, and the like; alloys of such metals, and sheets which are plated with such metals and laminated sheets of such metals. Substrates may also include polymers, glass, and various fibers, such as, for example, carbon/graphite; boron; quartz; aluminum oxide; glass such as E glass, S glass, S-2 GLASS® or C glass; and silicon carbide or silicon carbide fibers containing titanium. Commercially available fibers may include: organic fibers, such as KEVLAR® from DuPont; aluminum oxide-containing fibers, such as NEXTEL® fibers from 3M; silicon carbide fibers, such as NICALON® from Nippon Carbon; and silicon carbide fibers containing titanium, such as TYRRANO® from Ube. In particular embodiments, the curable compositions may be used to form at least a portion of a carbon fiber composite, a circuit board or a printed circuit board. In some embodiments, the substrate may be coated with a compatibilizer to improve the wetting and/or adhesion of the curable or cured composition to the substrate.

### Resulting Cured Product Properties

The cured or thermoset product prepared by curing the epoxy resin composition of the present invention advantageously exhibits an improved balance of processability and thermo-mechanical properties (e.g. pre-cured formulation viscosity, glass transition temperature, modulus, and fracture toughness). The combined use of the polyol and CSR at optimal levels provides formulations having lower viscosity, increased flexibility and elongation without detrimental drop in Tg of the resulting thermoset. Optimal polyol and CSR levels have increased flexibility and elongation.

The T_{g} of the thermoset product will depend on the curing agent and the epoxy resin used in the curable composition. In some embodiments, the T_{g} of the cured epoxy resins of the present invention may be from about 100° C. to about 300° C.; and more such as, for example, from about 100° C. to about 265° C. In some embodiments, the decrease in T_{g} of the cured compositions of the present invention compared to an analogous composition lacking a CSR and/or polyol toughening agent is less than 40° C.

Similarly, the fracture toughness of the thermoset product will depend on the curing agent and the epoxy resin used in the curable composition. Generally, the fracture toughness of the cured epoxy resins of the present invention may be from about 0.4 MPa/m^{1/2} to about 3 MPa/m^{1/2}; and from about 0.6 MPa/m^{1/2} to about 2 MPa/m^{1/2} in other embodiments. In some embodiments, the percentage increase in fracture toughness of the cured compositions of the present invention compared to an analogous composition lacking a CSR and/or polyol toughening agent may range from about 40 to about 200, and from about 40 to about 150 in other embodiments. In an embodiment, the elongation at break is greater than 9 percent.

### End-Use Applications

The epoxy resin compositions of the present invention are useful for the preparation of epoxy thermosets or cured products in the form of castings, coatings, films, adhesives, laminates, composites (e.g., filament winded stick pipes and spoolable pipes, pultrusion, resin transfer molding), encapsulants, potting compounds, and the like. In some embodiments, pultrusion, filament winding, casting, resin transfer molding, or vacuum infusion methods to process the epoxy resin compositions of the present invention are generally preferred.

As an illustration of the present invention, in general, the epoxy resin compositions may be useful for casting, potting, encapsulation, molding, and tooling. The present invention is particularly suitable for all types of electrical casting, potting, and encapsulation applications; for molding and plastic tooling; and for the fabrication of epoxy based composites parts, particularly for producing large epoxy-based parts produced by casting, potting and encapsulation. The resulting composite material may be useful in some applications, such as electrical casting applications or electronic encapsulations, castings, moldings, potting, encapsulations, injection, resin transfer moldings, composites, coatings and the like.

### EXAMPLES

The following examples and comparative examples further illustrate the present invention in detail but are not to be construed to limit the scope thereof.

All chemicals were purchased from Sigma-Aldrich unless stated otherwise. D.E.R.™ 383 (“DER 383”), PARALOID™ EXL 2300G, and PARALOID™ EXL 2314 CSR are commercially available from The Dow Chemical Company. Voranol™ 4000 LM polyol is a poly(propylene oxide) polyol of number average molecular weight 4000 commercially available from Dow. Voranol™ 4701 is a polyether polyol available from Dow. Poly-G® 55-56 is a polyol available from Arch Chemicals, Inc. Acclaim® 6320 is a polyol available from Bayer Material Science.

In the examples below, the following analytical methods were used: Fracture toughness was measured according to ASTM D5045, glass transition temperature was measured by Dynamic Mechanical Analysis (DMA), and mechanical properties were measured by ASTM D638 and D790.

### Example 1

15 grams of PARALOID EXL 2300G was dispersed into 35.1 grams of Poly G 55-56 via high shear mechanical dispersion. The core shell rubber dispersion was then mixed with 133.6 grams of D.E.R 383, 116.3 grams of methyltetrahydrophthalic anhydride and 3.0 grams of 1 methylimidazole via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed with 4 hours at 150° C. before it was slowly cooled to room temperature.

After conditioning at room temperature for about 2 weeks, the plaque was then machined into the appropriate test specimens for measuring fracture toughness and thermal mechanical properties. Results were reported in Table 1. The specimen had only 11.4% of tensile elongation at break and 1.66 MPa*m̂0.5, which implied that the thermoset was ductile and suitable for flexible pipe applications.

### Comparative Example A

160.3 grams of D.E.R 383 and 139.7 grams of methyltetrahydrophthalic anhydride and 3.0 grams of 1 methylimidazole were mixed via a Speedmixer™ by Hauschild at 2200 rpm for 2 minutes. The mixture was then placed in a vacuum chamber to remove any entrapped air. Once the mixture was fully degassed, it was pour into a mold to form a 3.25 mm thick plaque. The mold was immediately placed in a forced air convection oven and cured at 90° C. for 2 hours, followed by 4 hours at 150° C. before it was slowly cooled to room temperature.

After conditioning at room temperature for about 2 weeks, the plaque was then machined into the appropriate test specimens for measuring fracture toughness and thermal mechanical properties. Results were reported in Table 1. The specimen had only 6% of tensile elongation at break and 0.54 MPa*m̂0.5, which implied that the thermoset was brittle and not suitable for flexible pipe applications.

### Comparative Example B

141.6 grams of D.E.R 383, 123.3 grams of methyltetrahydrophthalic anhydride, 35.1 grams of Poly G 55-56, and 3.0 grams of 1 methylimidazole were mixed via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 150° C. before it was cooled to room temperature slowly.

After conditioning at room temperature for about 2 weeks, the plaque was then machined into the appropriate test specimens for measuring fracture toughness and thermal mechanical properties. Results were reported in Table 1. The specimen had only 8.5% of tensile elongation at break and 0.90 MPa*m̂0.5. While slight improvement in elongation and fracture toughness was observed, and the composition failed to meet the minimum requirement of 8.0% elongation at break.

### Comparative Example C

25.9 grams of PARALOID EXL 2300G was mechanically dispersed in 146.6 grams of DER 383 to form a homogeneous dispersion. The mixture was then mixed with 127.6 grams of methyltetrahydrophthalic anhydride, and 3.0 grams of 1 methylimidazole were then mixed via a Speedmixer™ by Hauschild at 2200 rpm for 2 minute. The mixture was then placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 150° C. before it was slowly cooled to room temperature slowly.

After conditioning at room temperature for about 2 weeks, the plaque was then machined into the appropriate test specimens for measuring fracture toughness and thermal mechanical properties. Results were reported in Table 1. The specimen had only 5.4% of tensile elongation at break and 1.89 MPa*m̂0.5. While a significant improvement in fracture toughness was observed, and the composition failed to meet the minimum requirement of 8.0% elongation at break.

### Example 2

22.5 grams of PARALOID EXL 2314 was dispersed into 67.5 grams of Voranol 4701 via high shear mechanical dispersion. The core shell rubber dispersion was then mixed with 112.2 grams of D.E.R 383 and 97.8 grams of methyltetrahydrophthalic anhydride and 3.0 grams of 1 methylimidazole were mixed via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed into a forced air convection oven and cured at 90° C. for 2 hours, followed by 4 hours at 150° C. before it was slowly cooled to room temperature.

After conditioning at room temperature for about 2 weeks, the plaque was then machined into the appropriate test specimens for measuring fracture toughness and thermal mechanical properties. Results were reported in Table 1. The specimen had 21.8% of tensile elongation at break and 1.14 MPa*m̂0.5, which implied that the thermoset was ductile and suitable for flexible pipe applications.

### Comparative Example D

124.3 grams of D.E.R 383, 108.2 grams of methyltetrahydrophthalic anhydride, 67.5 grams of Voranol 4701, and 3.0 grams of 1-methylimidazole were mixed via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 150° C. before it was slowly cooled to room temperature.

After conditioning at room temperature for about 2 weeks, the plaque was then machined into the appropriate test specimens for measuring fracture toughness and thermal mechanical properties. Results were reported in Table 1. The specimen had only 6.6% of tensile elongation and 0.80 MPa*m̂0.5. While a slight improvement in elongation and fracture toughness was observed, the composition failed to meet the minimum requirement of 9.0% elongation at break.

### Example 3

22.5 grams of PARALOID EXL 2314 was dispersed into 67.5 grams of Acclaim 6320 via high shear mechanical dispersion. The core shell rubber dispersion was then mixed with 112.2 grams of D.E.R 383 and 97.8 grams of methyltetrahydrophthalic anhydride and 3.0 grams of 1-methylimidazole were then mixed via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plague. The mold was immediately placed in a forced air convection oven and cured at 90° C. for 2 hours, followed with 4 hours at 150° C. before it was cooled to room temperature slowly.

After conditioning at room temperature for about 2 weeks, the plaque was then machined into the appropriate test specimens for measuring fracture toughness and thermal mechanical properties. Results were reported in Table 1. The specimen had 20.2% of tensile elongation at break and 1.12 MPa*m̂0.5, which implied that the thermoset was ductile and suitable for flexible pipe applications.

### Example 4

22.8 grams of PARALOID EXL 2300G was mechanically dispersed in 129.0 grams of DER 383 to form a homogeneous dispersion. The mixture was then mixed with 112.3 grams of methyltetrahydrophthalic anhydride, 36 grams of Poly G 55-56, and 3.0 grams of 1-methylimidazole via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 93° C. for 7 min., 107° C. for 7 min., 118° C. for 7 min., 127° C. for 9 min., and 135° C. for 9 min before it was slowly cooled to room temperature slowly.

After conditioning at room temperature for about 2 weeks, the plaque was then machined into the appropriate test specimens for measuring fracture toughness and thermal mechanical properties. Results were reported in Table 1. The specimen had only 16.1% of tensile elongation at break and 2.2 MPa*m̂0.5.

### Example 5

22.8 grams of PARALOID EXL 2300G was mechanically dispersed in 129.0 grams of DER 383 to form a homogeneous dispersion. The mixture was then mixed with 112.3 grams of methyltetrahydrophthalic anhydride, 36 grams of Voranol 4701, and 3.0 grams of—methylimidazole via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 93° C. for 7 min., 107° C. for 7 min., 118° C. for 7 min., 127° C. for 9 min., and 135° C. for 9 min before it was slowly cooled to room temperature.

After conditioning at room temperature for about 2 weeks, the plaque was then machined into the appropriate test specimens for measuring fracture toughness and thermal mechanical properties. Results were reported in Table 1. The specimen had only 14.6% of tensile elongation at break and 1.6 MPa*m̂0.5.

### Example 6

22.8 grams of PARALOID EXL 2300G was mechanically dispersed in 129.0 grams of DER 383 to form a homogeneous dispersion. The mixture was then mixed with 112.3 grams of methyltetrahydrophthalic anhydride, 36 grams of Voranol P4000, and 3.0 grams of 1-methylimidazole via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 93° C. for 7 min., 107° C. for 7 min., 118° C. for 7 min., 127° C. for 9 min., and 135° C. for 9 min before it was slowly cooled to room temperature.

After conditioning at room temperature for about 2 weeks, the plaque was then machined into the appropriate test specimens for measuring fracture toughness and thermal mechanical properties. Results were reported in Table 1. The specimen had only 10.5% of tensile elongation at break and 1.7 MPa*m̂0.5.

TABLE 1

| | | Comparative | Comparative | Comparative | | Comparative | | | | |
|---|---|---|---|---|---|---|---|---|---|---|
| | Example 1 | Example A | Example B | Example C | Example 2 | Example D | Example 3 | Example 4 | Example 5 | Example 6 |
| DER 383 | 133.6 | 160.3 | 141.6 | 146.6 | 112.2 | 124.3 | 112.23 | 129.0 | 129.0 | 129.0 |
| MTHPA | 116.3 | 139.7 | 123.3 | 127.6 | 97.8 | 108.2 | 97.77 | 112.2 | 112.2 | 112.2 |
| PARALOID EXL | 15.0 | | | 25.8 | | | | 22.8 | 22.8 | 22.8 |
| 2300G | | | | | | | | | | |
| PARALOID EXL | | | | | 22.5 | | 22.5 | | | |
| 2314 | | | | | | | | | | |
| Poly G 55-56 | 35.1 | | 35.1 | | | | | 36 | | |
| Voranol 4701 | | | | | 67.5 | 67.5 | | | 36 | |
| Acclaim 6320 | | | | | | | 67.5 | | | |
| Voranol P 4000 | | | | | | | | | | 36 |
| 1 methylimidazole | 3.0 | 3.0 | 3.0 | 3.0 | 3.0 | 3.0 | 3.0 | 3.0 | 3.0 | 3.0 |
| Tg, ° C. | 106 | 140 | 104 | 142 | 117 | 116 | 125 | 110 | 124 | 128 |
| Tensile Modulus, | 2780 | 3267 | 2843 | 2748 | 1055 | 1424 | 936 | 2300 | 2110 | 1980 |
| MPa | | | | | | | | | | |
| Tensile Elongation | 11.4 | 6.1 | 6.6 | 5.4 | 21.8 | 8.5 | 20.2 | 16.1 | 14.6 | 10.5 |
| at Break, % | | | | | | | | | | |
| Flexual Modulus, | 2613 | 3151 | 3073 | 3041 | 1153 | 1637 | 1347 | 2010 | 1920 | 1810 |
| MPa | | | | | | | | | | |
| Flexual Strain, % | 61 | 9.4 | 89 | 6.6 | no break | 15.2 | 14.6 | >6% | >6% | >6% |
| Fracture Toughness, | 1.66 | 0.54 | 0.80 | 1.89 | 1.14 | 0.90 | 1.12 | 2.20 | 1.6 | 1.7 |
| MPa * m\hat{ }0.5 | | | | | | | | | | |

1. A curable resin composition comprising:
a) an epoxy resin;
b) an anhydride hardener;
c) a polyol;
d) a core shell rubber, and
e) a catalyst.

2. A curable resin composition in accordance with claim 1 wherein the curable resin composition is prepared by dispersing said core shell rubber in said epoxy resin to form a dispersion, and admixing said dispersion with said hardener, said catalyst, and said polyol component.

3. A curable resin composition in accordance with claim 1 wherein the curable resin composition is prepared by dispersing said core shell rubber in said anhydride hardener to form a dispersion, and admixing said dispersion with said epoxy resin, said catalyst, and said polyol component.

4. A curable resin composition in accordance with claim 1 wherein the curable resin composition is prepared by dispersing said core shell rubber in said polyol component to form a dispersion, and admixing said dispersion with said epoxy resin, said catalyst, and said hardener.

5. A curable resin composition in accordance with claim 1 wherein the epoxy resin is present in an amount in the range of from 10 weight percent to 90 weight percent, the anhydride hardener is present in an amount in the range of from 10 weight percent to 90 weight percent, the polyol is present in an amount in the range of from 1 weight percent to 30 weight percent, the core shell rubber is present in an amount in the range of from 1 weight percent to 25 weight percent, and the catalyst is present in an amount in the range of from 0.1 weight percent to 10 weight percent, based on the total weight of the curable resin composition.

6. A curable resin composition in accordance with claim 1 wherein the anhydride hardener is selected from the group consisting of aromatic and cycloaliphatic anhydrides, and combinations thereof.

7. A curable resin composition in accordance with claim 6 where the anhydride hardener is nadic-methyl-anhydride or methyl-tetrahydrophtalic-anhydride.

8. A curable resin composition in accordance with claim 1 wherein said polyol component is selected from the group consisting of polyether polyols, polyester polyols, polycarbonate polyols, and combinations thereof.

9. A curable resin composition in accordance with claim 8 wherein the polyol component is selected from the group consisting of a polyether polyol derived from ethylene oxide, propylene oxide, butylene oxide, tetrahydrofuran or mixtures thereof, a polyester polyol derived from succinic acid, glutaric acid, adipic acid, phthalic anhydride, isophthalic acid, terephthalic acid, or mixtures thereof copolymerized with ethylene glycol, 1,2-propanediol, 1,4-butanediol, 1,6-hexanediol, neopentyl glycol, diethylene glycol, glycerol, trimethylolpropane, or mixtures thereof, a polyester polyol derived from caprolactone, a polycarbonate polyol derived from ethylene glycol, 1,2-propanediol, 1,4-butanediol, 1,6-hexanediol, neopentyl glycol, diethylene glycol, glycerol, trimethylolpropane, or mixtures thereof copolymerized with a carbonate precursor, and mixtures of any two or more polyols thereof.

10. A curable resin composition in accordance with claim 1 wherein said polyol component comprises a polyol with an average molecular weight of from 2000 to 12000 and an average functionality of 1.5 to 6.0.

11. A curable resin composition in accordance with claim 1 wherein said catalyst is selected from the group consisting of imidazoles, substituted imidazoles, quaternary ammonium salts, chromium compounds and mixtures thereof.

12. A process for preparing a curable resin composition comprising:
(a) dispersing a core shell rubber into a component selected from the group consisting of a polyol component, a hardener component, and an epoxy resin component with a high shear mixer in a dispersion zone under dispersion conditions to form a core shell rubber dispersion; and (b) admixing the core shell rubber dispersion into an i) a catalyst and ii) an epoxy formulation comprising at least one of an epoxy resin, an anhydride hardener, and a polyol to form the curable resin composition.

13. A cured resin composition comprising:
a) an epoxy resin;
b) an anhydride hardener;
c) a polyol component selected from the group consisting of a polyether polyol, a polyester polyol, a polycaprolactone polyol, a hydroxyl-terminated polybutadiene, and mixtures thereof; and
d) a core shell rubber comprising a rubber particle core and a shell layer wherein said core shell rubber has a particle size of from 0.01 μm to 0.5 μm.

14. A cured resin composition in accordance with claim 13 having an elongation at break greater than 9 percent.

15. An article made from the cured resin composition of claim 13, said article selected from the group consisting of a composite, a coating, a laminate, and an adhesive.
